(19) United States
(12) Patent Application Publication
(10) Pub. No.: US 2025/0131358 A1
(43) Pub. Date: Apr. 24, 2025

(54) AUTOMATED WORKFLOWS TO AUTOMATE ENRICHMENT OF KNOWLEDGE GRAPHS AND DATA CATALOGS AND TO AUTOMATE ADHERENCE TO DATA GOVERNANCE POLICIES

(71) Applicant: data.world, Inc., Austin, TX (US)

(72) Inventors: Nancy Prabhakar, Austin, TX (US); Olga Fink, Austin, TX (US); Jona Fenocchi, Austin, TX (US); Marc Lebrun, Lebrun, TX (US); Shad Reynolds, Austin, TX (US); Juan Sequeda, Austin, TX (US); Andrew Katz, Austin, TX (US); Jon Loyens, Austin, TX (US); Bryon Jacob, Austin, TX (US)

(73) Assignee: data.world, Inc., Austin, TX (US)

(21) Appl. No.: 18/383,010

(22) Filed: Oct. 23, 2023

(51) Int. Cl. G06Q 10/0633

(52) U.S. Cl. CPC G06Q 10/0633

(57) ABSTRACT

Various embodiments relate generally to data science and data analysis, computer software and systems, based on graph-based data arrangements, among other things, and, more specifically, to a computing platform configured to generate configurable automation templates and automation executable programs that automate workflows based on process models to effectuate automated data governance of datasets, including graph-based data stored in one or more graphs, such as a knowledge graph, a data catalog, etc., whereby in at least one example, automated workflows can provide automatic enrichment of datasets, such as multi-layered knowledge graph data that may include data catalog data. In some examples, a method may include receiving data representing activation of an automated workflow template configured to perform a process workflow, receiving configuration data, linking an automated workflow template to executable instructions, and retrieving data representing a type of process flow, which may data including enriched graph data to modify graph data.

### FIELD

Various embodiments relate generally to data science and data analysis, computer software and systems, and data-driven control systems and algorithms based on graph-based data arrangements, among other things, and, more specifically, to a computing platform configured to generate configurable automation templates and automation executable programs that automate workflows based on process models to effectuate automated data governance of datasets, including graph-based data stored in one or more graphs, such as a knowledge graph, a data catalog, or an otology, whereby in at least one example, automated workflows can provide automatic enrichment of datasets, such as multi-layered knowledge graph data that may include data catalog data.

### BACKGROUND

Advances in computing hardware and software ignited exponential growth in the generation of vast amounts of data due to increased computations and analyses in numerous areas, such as in the various scientific and engineering disciplines. Also, advances in conventional data storage technologies provide an ability to store increasing amounts of generated data, especially in association with enterprise computing services. Moreover, different computing platforms and systems, different database technologies, and different data formats gives rise to difficulties in conventionally maintaining and updating data arrangements and datasets, including graph-based data arrangements, such as knowledge graphs and portions thereof.

While conventional approaches are functional, various approaches are not well-suited to significantly overcome difficulties of complexities of increases in amounts of datasets associated with knowledge graphs and portions thereof, which may include data catalog data. For example, notions of conventional knowledge graphs are expected to surpass one (1) trillion facts or triples (e.g., a triple statement) or more, which introduces further complexities to interact (e.g., manually) with knowledge graphs to facilitate data governance and adherence to enterprise data policies. Generally, enterprise data policies are usually set forth as standards to ensure data quality standards are met (e.g., to enhance accuracy of knowledge graph data), as well as to ensure sensitive data is secure, among other policy requirements.

Organizations, including enterprises, continually strive to understand, manage, and productively use large amounts of enterprise data and increasingly complex data computing systems and platforms. In some conventional approaches, typical developers of data catalog management services or functions are generally based on knowledge graphs and might implement process models to generate and execute workflows to manage and update graph-based datasets. In at least one drawback, conventional development of workflows typically is performed manually. That is, specialized knowledge of developing process models is usually necessary to modify business processes. Enterprise customers including data producers and data consumers, such as users in different enterprise roles, need not necessarily be skilled software developers to develop workflows using process models. Therefore, enterprise customers usually rely on the services of suppliers, developers, or manufacturers of knowledge graph management software and functional processes. Typically, reliance on conventional actions increases cycle time to develop workflows, increases cost of developing the same, and decreases autonomy of enterprise customers to create workflows independently.

Further, with the rise of cloud-based “data lakes,” and other disparate and remote data sources and storage repositories that can correspond with different data formats, conventional mechanisms to manage, as well as govern, vast amounts of data used in conventional implementations of knowledge graph management are suboptimal.

Thus, what is needed is a solution for facilitating techniques to optimize management and governance of data catalogs and knowledge graphs, including, among other things, automating generation and execution of workflows to enrich data in graph-based data arrangements, without the limitations of conventional techniques.

### BRIEF DESCRIPTION OF THE DRAWINGS

Various embodiments or examples (“examples”) of the invention are disclosed in the following detailed description and the accompanying drawings:

FIG. 1A is a diagram depicting a computing system configured to generate and implement automated workflows, according to some embodiments;

FIG. 1B depicts an illustrative example of an automated workflow template including a workflow process model, according to some examples;

FIG. 2 is a flow diagram as an example of implementing automated workflow templates establishing automated workflows, according to some embodiments;

FIG. 3 illustrates an exemplary layered architecture for implementing an automated workflow engine application layer as an application architecture, according to some examples;

FIG. 4 depicts an example of an automation object model configured to implement an automated workflow template, according to some examples;

FIG. 5 is a flow diagram as an example of generating automated workflow templates, according to some embodiments;

FIG. 6 depicts an example of an automated workflow processor configured to provide a configuration interface to establish an automated workflow, according to some examples;

FIG. 7 is a flow diagram as an example of a process configured to enrich graph data, including a portion of a knowledge graph, according to some embodiments;

FIG. 8 depicts an example of a task manager interface to facilitate management of tasks of a workflow, according to some examples;

FIG. 9 depicts an example of an insight interface to facilitate management processes of an automated workflow, according to some examples; and

FIG. 10 depicts an example of a system architecture configured to implement automated workflows and data governance, according to an example.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in any arbitrary order, unless otherwise provided in the claims.

A detailed description of one or more examples is provided below along with accompanying figures. The detailed description is provided in connection with examples, but is not limited to any particular example. The scope is limited only by the claims, and numerous alternatives, modifications, and equivalents thereof. Numerous specific details are set forth in the following description to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture implementing hardware or software, or both, using various computing resources that are configured to provide computing features, functions, processes, elements, components, or parts, without any particular limitation as to the type, make, manufacturer, developer, provider, configuration, programming or formatting language, service, class, resource, specification, protocol, or other computing or network attributes. As used herein, “software” or “application” may also be used interchangeably or synonymously with, or refer to, a computer program, software, program, firmware, or any other term that may be used to describe, reference, or refer to a logical set of instructions that, when executed, performs a function or set of functions in association with a computing system or machine, regardless of whether physical, logical, or virtual and without restriction or limitation to any particular implementation, design, configuration, instance, or state. Further, “platform” may refer to any type of computer hardware (hereafter “hardware”) or software, or any combination thereof, that may use one or more local, remote, distributed, networked, or computing cloud (hereafter “cloud”)-based computing resources (e.g., computers, clients, servers, tablets, notebooks, smart phones, cell phones, mobile computing platforms or tablets, and the like) to provide an application, operating system, or other computing environment, such as those described herein, without restriction or limitation to any particular implementation, design, configuration, instance, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, or state) may be used for processing and/or storage of varying quantities, types, structures, and formats of data, without restriction or limitation to any particular implementation, design, or configuration.

As used herein, data may be stored in various types of data structures including, but not limited to databases, data repositories, data warehouses, data stores, or other data structures or memory configured to store data in various computer programming languages and formats in accordance with various types of structured and unstructured database schemas such as SQL, MySQL, NoSQL, DynamoDB™, etc. Also applicable are computer programming languages and formats similar or equivalent to those developed by data facility and computing providers such as Amazon® Web Services, Inc. of Seattle, Washington, FMP, Oracle®, Salesforce.com, Inc., or others, without limitation or restriction to any particular instance or implementation. DynamoDB™, Amazon Elasticsearch Service, Amazon Kinesis Data Streams (“KDS”)™, Amazon Kinesis Data Analytics, and the like, are examples of suitable technologies provide by Amazon Web Services (“AWS”). Another example of cloud computing services includes the Google® cloud platform that may implement a publisher-subscriber messaging service (e.g., Google® pub/sub architecture). Yet in another example, cloud computing and messaging services may include Apache Kafka, Apache Spark, and any other Apache software application and platforms, which are developed and maintained by Apache Software Foundation of Wilmington, Delaware, U.S.A. Further, references to databases, data structures, memory, or any type of data storage facility may include any embodiment as a local, remote, distributed, networked, cloud-based, or combined implementation thereof.

In some examples, data may be formatted and transmitted via electronic messaging channels (i.e., transferred over one or more data communication protocols) or via any number of application programming interfaces (“APIs”) between computing resources using various types of data communication and transfer protocols such as Hypertext Transfer Protocol (“HTTP”), Transmission Control Protocol (“TCP”)/Internet Protocol (“IP”), Internet Relay Chat (“IRC”), SMS, text messaging, instant messaging (“IM”), File Transfer Protocol (“FTP”), or others, without limitation. As described herein, disclosed processes implemented as software may be programmed using Java®, JavaScript®, Java™ Archive (e.g., .jar files), Scala, Python™, XML, HTML, and other data formats and programs, without limitation. Disclosed processes herein may also implement software such as SQL or SPARQL applications (or equivalent thereof), browser applications (e.g., Firefox™) and/or web applications, among others. In some example, a browser application may implement a JavaScript framework, such as Ember.js, Meteor.js, ExtJS, AngularJS, and the like. References to various layers of an application architecture (e.g., application layer or data layer) may refer to a stacked layer application architecture such as the Open Systems Interconnect (“OSI”) model or others. As described herein, a distributed data file may include executable instructions as described above (e.g., JavaScript® or the like) or any data constituting content (e.g., text data, video data, audio data, etc.), or both, any of which may be represented or include metadata associated with a data catalog or a knowledge graph, or both.

In some examples, systems, software, platforms, and computing clouds, or any combination thereof, may be implemented to facilitate development and execution of automated workflows, as management or governance of graph-based data (e.g., data catalogs).

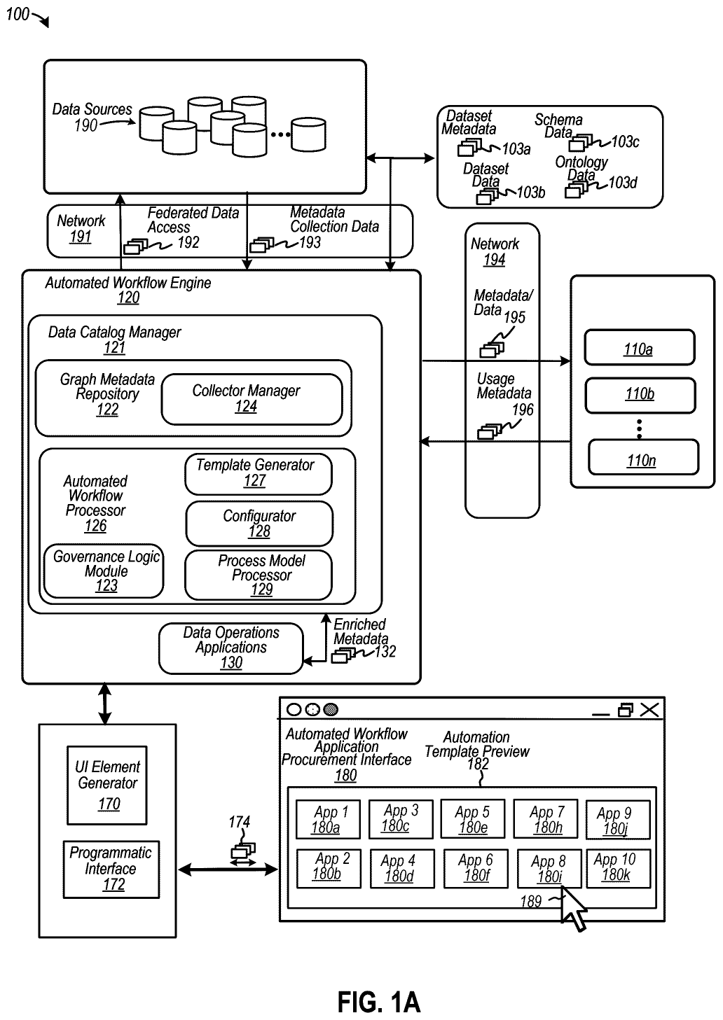

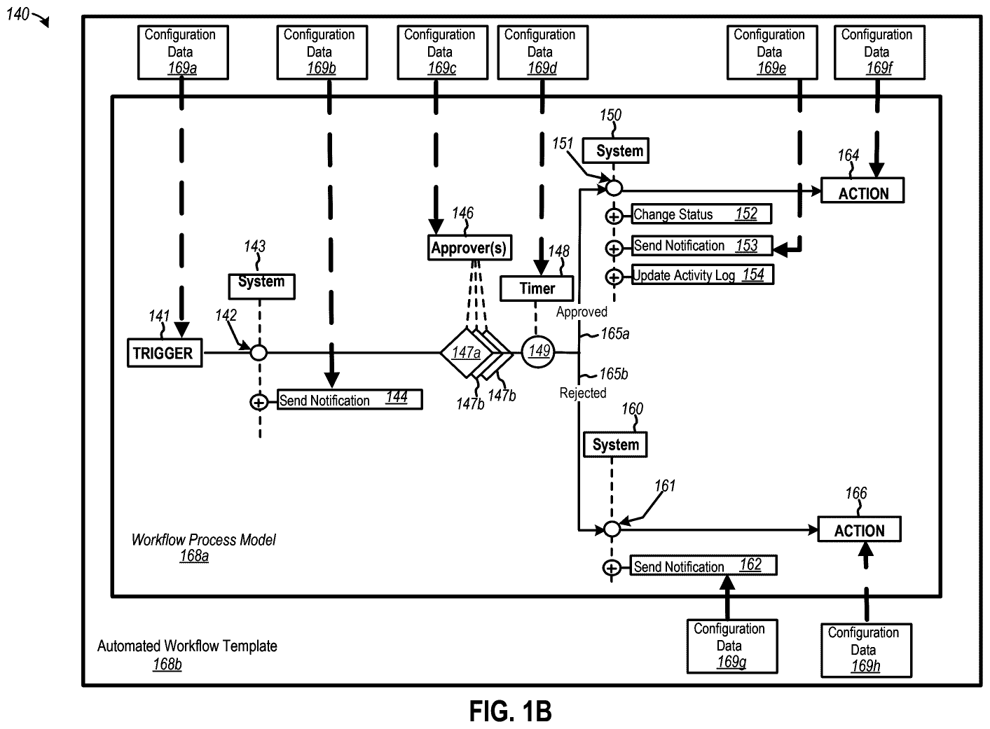

FIG. 1A is a diagram depicting a computing system configured to generate and implement automated workflows, according to some embodiments. Diagram 100 depicts an example of a networked (e.g., cloud-based) computing system, such as an automated workflow engine 120 as a computerized tool that may be configured to access any amount of data (e.g., dataset data and metadata) via a network 191 from disparate data sources 190. Automated workflow engine 120 as a computerized tool may be configured to execute instructions to perform one or more of the following: (1) facilitate automatic generation of workflow templates, or “automated workflow templates,” (2) provide an networked application to inject configuration data into a type of an automated workflow template to customize one or more instances of an automated workflow to perform various functions of different process workflows based on the type of automated workflow template, (3) capture configuration data and resulting workflow data (e.g., task management data) for loading into, for example, data sources 190 to enrich or extend data in a data catalog and a knowledge graph (e.g., as an “active knowledge graph”), (4) provide various automated workflow templates as applications, which may be presented in an application template preview portion of an interface (e.g., as an automated workflow “app store”), (5) provide logic configure to analyze data values against one or more data governance policies, and (6) provide any other number of functionalities associated with automating workflows, enriching graph-based data arrangements, data governance, etc.

In some examples, data catalog manager 121 may be configured to perform one or more of the functions of automated workflow engine 120. Diagram 100 depicts automated workflow engine 120 including a data catalog manager 121 and data operations applications 130. Further, data catalog manager 121 is shown to include a graph metadata repository 122 and automated workflow processor 126, any of which may perform functions independently and disposed in any distributed computing system. Further, graph metadata repository 122 may include a collector manager 124, whereas automated workflow processor 126 may include a template generator 127, a configurator 128, a process model processor 129, and a governance logic module 123.

In some examples, graph metadata repository 122 may be configured to access or store one or more of dataset data (e.g., “resource data’) and metadata, including metadata profile data, associated with a knowledge graph. In some examples, metadata profile data (or profile metadata) may include field configurations, layouts, lists, data types, etc., including, for instance, metadata describing a user and its attributes (e.g., name, location, role, skill set, etc.). For example, metadata profile data may be a metadata profile data file that includes data attributes of other data and/or executable instructions configured to configure or customize data fields associated with (and to be presented in association with) a data catalog. Also, a metadata profile data file may be configured to implement lists and data types, as well as to provide graphical user interface layouts, etc., any of which may, in some cases, be associated with a user or an electronic user account of a networked application configured to implement an automated workflow template.

Note that “resource data,” in at least some cases, may represent metadata or data resources, such as business terms, collections, datasets, projects, insights and the like. Resource data may also refer to data in a data catalog and may include units of metadata describing a description of tabular data, a status description, personal identifiable information (“PII”), whether external use outside of an enterprise is authorized, whether a non-disclosure agreement (“NDA”) relates to a data resource, permissions associated with a resource, one or more relevant calculations for presentation in a user interface, and other resources.

Collector manager 124 may include logic configured to form a data catalog to include at least metadata, such as metadata collection data 193, from one or more data sources 190. In some examples, collector manager 124 may be configured to receive metadata collection data 193 in a jar file (e.g., Java Archive file). An example of collector manager 124 is a Data.world™ catalog collector (“dwcc”) provided or developed by data.world, Inc., of Austin Texas, U.S.A. In an example not shown, collector manager 124 may include a connector manager to establish data communications with a data source 190 or a third-party computing system to access catalog metadata or access data for querying or analyzing data.

Examples of data sources 190 include data from data source systems, such as Salesforce, Inc.™ of San Francisco and Marketo, Inc.™ of San Mateo, CA, as well as data from extract, transform, and load (ETL) data sources, such as Dbt™ Labs, Inc. and Fivetran™ of Oakland, CA. Other examples of data sources 190 include data associated with data lakes and data warehouses, such as Snowflake, Inc.™ of Boseman, MT and Databricks™ of San Franciso, CA. Other data sources are also suitable data associated with knowledge graph data and data catalog data.

In some examples, data sources 190, whether stored locally or remotely, may derive dataset data from any type of data in any format, such as structured data (e.g., data stored as data tables in relational databases accessible via, for example, SQL or other structured database languages), semi-structured data (e.g., XML-formatted data, metadata, spreadsheet data, etc.), and unstructured data (e.g., PDF documents, GitHub™ Jupyter Notebook data, text document data, email document data, website data, etc.). As such, in some examples, a query may be implemented as either a relational-based query (e.g., in an SQL-equivalent query language) or a graph-based query (e.g., in a SPARQL-equivalent query language). In some cases, a relational-based query may be converted interchangeably into a graph-based query. Further, a query may be implemented as either an implicit federated query or an explicit federated query.

Collector manager 124 may include logic configured to transmit via network 194 metadata/data 195 to one or more analytics applications 110a to 110n, and collector manager 124 may be configured to receive usage metadata 196 from analytics applications 110a to 110n. In some cases, analytics applications 110a to 110n may be cloud-based business intelligence (“BI”) computerized tools configured to analyze and visualize both metadata/data 195 to generate usage metadata 196 to, for example, identify usage of dataset data (e.g., whether associated metadate is stale), to identify users or user accounts that consume dataset data, to analyze data to generate summaries or distillations of large amounts of data (including visualizations, such a graphs), and other characteristics to assist in data management. Examples of analytics applications 110a to 110n include Looker Data Sciences, Inc. of Santa Cruz, CA (subsidiary of Google, Inc.) and Tableau Software™ of Seattle, WA (subsidiary of Salesforce, Inc.).

In some examples, automated workflow engine may be configured to access data sources 190 as well as any other data, including dataset metadata 103a (e.g., descriptor data or information specifying dataset attributes), dataset data 103b (e.g., referenced data of interest, such as principal data, stored in any local or remote data storage, such as data in data sources 190), schema data 103c (e.g., sources, such as schema.org, that may provide various types and vocabularies, glossaries, data dictionaries, and the like), and ontology data 103d from any suitable ontology or any other suitable types of data sources.

Automated workflow processor 126 may be configured to manage generation of automated workflow templates. Template generator 127 may include logic configured to generate files representing automated workflow templates each configured to perform a specific process, such as a business process or any other computerized process to facilitate an enterprise process. Template generator 127 may form automated workflow templates to identify initiation of a process, such as a “trigger,” as well as termination of the process, for example as by an “action” to be performed. Template generator 127 may generate automated workflow templates to include one or more data arrangements having specific fields with which process flow provide, for example, notification of process flow status (e.g., “notify” via email, text, etc., or “change status,” etc.), tasks that are to be performed (e.g., “accept and do task,” or “re-assign task”), time periods in which a response or a task is to performed, and the like. Any of the portions of constructing an automated workflow template may be performed automatically, semi-automatically, or manually.

Template generator 127 may generate an automated workflow template linked to a process model. In some examples, a process model may be compliant with a Business Process Model and Notation (“BPMN”) standard, such as that maintained by Object Management Group, Inc., or OMG™, Standards Development Organization® at http//www(dot)bpmn(dot)org. Also, template generator 127 may be configured to generate an automated workflow template linked to executable objects of an object-oriented programming language, such a Java®, Python™, or the like, to, for example, provide functionality of an automated workflow based on a BPMN model. Note that template generator 127 may be configured to implement any type of metadata, such as metadata collection data 193 and usage metadata 196, among others. According to some examples, template generator 127 may include a workflow engine to execute processes defined by an instance of an automated workflow. In at least one case, a workflow engine maintained by Camunda, Inc.™ of San Fransico, CA, may be implemented to execute processes, such as defined in accordance with Business Process Modeling Notation, or BPMN. Note that examples of process models described herein are not limited to BPMN models, and process models may be implemented by another process model other than BPMN.

Examples of automated workflow templates may include a first automated workflow template that may be configured to require one or more users or electronic user accounts to obtain approval for an action requested by a user, such as a request to access or modify data in a data catalog. The first automated workflow template may function to facilitate “data access” as a data access template. Initiation of the first automated workflow can be triggered responsive to a user input or an automatic determination that metadata ought to be accessed. Automatic determinations may be made based on algorithms configured to implement machine learning to derive an automatic input based on various conditions. In one example, a second automated workflow template may be configured to detect non-compliant data (e.g., in view of a governance policy), such as non-anonymized sensitive data (e.g., credit card numbers or social security numbers). In turn, the second automated workflow template may be configured to change a status of non-compliant data as “accessible” to a status of “inaccessible” to prevent access until the issue is resolved. Next, the second automated workflow template may operate to anonymize the non-compliant data using, for example, a PrivateAI application provided by PRIVATEAI™ of Toronto, Canada. Furthermore, the second automated workflow template (or another workflow process) may be configured to modify a knowledge graph and a data catalog from which the non-compliant data was associated. Or, the second automated workflow template may be configured to detect and resolve incomplete metadata by adding descriptions, terms of use, etc. A second automated workflow template may be referred to as a “metadata enrichment” template.

A third automated workflow template may be configured to determine whether metadata of at least a portion of a knowledge graph (e.g., a resource, resource data, or a dataset) is “complete” in accordance with one or more governance policies. For example, the third automated workflow template may be configured to enrich or revise metadata associated with at least a portion of a knowledge graph upon detecting a trigger, such as a non-compliant policy value. An example of a policy value is a metadata completeness score measured against a threshold. A completeness score may be automatically computed based on an aggregation of metadata that, for example, are not null (or without data values). A third automated workflow template may be referred to as a “metadata completeness” template.

A fourth automated workflow template may be configured to determine whether metadata is associated with a degree of “freshness” (i.e., is not stale or unmaintained) in accordance with one or more governance policies. For example, a fourth automated workflow template may be configured to refresh metadata associated with at least a portion of a knowledge graph upon detecting a trigger, such as a period value of time (e.g., every 6 months) over which metadata for a resource, a data asset, or a data product may not have been reviewed or accessed (e.g., in accordance with a threshold of reviews or accesses). Examples of data products include datasets, data streams, data feeds, as well as APIs, code, data models, analytics models, dashboards, and the like. A fourth automated workflow template may be referred to as a “metadata freshness” template.

A fifth automated workflow template may be configured to determine whether metadata is associated with an identified owner in accordance with one or more governance policies. A fifth automated workflow template may be configured to trigger a workflow responsive of detecting no identified owner (e.g., a user terminates employment with an enterprise or changes roles), whereby the fifth automated workflow template may be configured to automatically delegate ownership to another user that has similar characteristics or attributes (e.g., similar roles, similar permissions, etc.). A fifth automated workflow template may be referred to as an “assign ownership” template. A sixth automated workflow template may be configured to detect an event or a data value, such as a status, associated with metadata in accordance with one or more governance policies. A sixth automated workflow template may be configured to trigger a workflow responsive of detecting whether a dataset, a data file, or a stream of data includes a certain data value (e.g., any combination of alpha-numeric characters, including “strings” of text). The sixth automated workflow template may be configured to automatically execute an action. For example, if a data value in metadata representing a ‘description’ (of a dataset) is detected, the sixth automated workflow template may be configured to take an action, such as adding tag to metadata. A sixth automated workflow template may be referred to as a “Status-based Action” template. In various examples, the term data value may be used interchangeably with “attribute,” “characteristic,” “property,” and the like.

Further, any number of other automated workflow templates may be created to perform any workflow function, regardless of whether a created workflow template is associated with governance policies. Also, configuration data, status data (e.g., no identified owner), computed data, workflow resultant data, and any other data may be automatically uploaded into a knowledge graph to form a another portion of the knowledge graph by adding workflow-based datasets and triples. In some examples, template generator 127 may include a template repository configured to store automated workflow templates, each of the automated workflow templates being associated with a link to a user input at an interface, such as an automated workflow application procurement interface 180. Yet, in some other examples, template generator 127 may be configured to implement a graph-based ontology to generate a template based on a first subset of triples and implement configuration data associated with a second subset of triples, wherein a function of the template is to extend a data catalog or a knowledge graph, or both.

As shown, automated workflow engine 120 is electronically coupled to automated workflow application procurement interface 180 via a user interface (“UI”) element generator 170 and a programmatic interface 172 (e.g., via a network). UI generator 170, for example, may cause generation of UI elements, such as a container window (e.g., icon to invoke storage, such as a file), a browser window, a child window (e.g., a pop-up window), a menu bar (e.g., a pull-down menu), a context menu (e.g., responsive to hovering a cursor over a UI location), graphical control elements (e.g., user input buttons, check boxes, radio buttons, sliders, etc.), and other control-related user input or output UI elements. Programmatic interface 172 may include logic configured to couple automated workflow engine 120, including template generator 127, or any computing device configured to present automated workflow application procurement interface 180 via, for example, any network, such as the Internet. In one example, programmatic interface 172 may be implemented to include an application programming interface (“API”), such as a REST API, etc., and may be configured to use, for example, HTTP protocols (or any other protocols) to facilitate electronic communication of automated workflow template data 174. According to some examples, one or more of user interface (“UI”) element generator 170 and a programmatic interface 172 may be implemented internal or external to automated workflow engine 120, a computing device associated with automated workflow application procurement interface 180, or any combination thereof.

Template generator 127 may further include logic configured to present user inputs representing various applications (“App 1”) 180a to (“App 10”) 180k in an automation template preview 182 of interface 180, any of which is configured receive user input and generate a data signal to invoke implementation of an automation template. At least some of applications 180a to 180k may include any of the above-described automated workflow templates, as well as any other type of automated workflow templates. Automation template preview portion 182 of interface 180 may be configured to receive a user input via a cursor 189 (or any other selection mechanism) to select application 180i. Activation of automated workflow template of application 180i may be configured to form (via configuration data) an instance or instantiation of an automated workflow (e.g., a specialized, immutable, or derived class-based template) based on an automated workflow (e.g., a generalized or a base class-based template). Note that in some cases, while an instance of an automated workflow may be immutable, an instance of an automated workflow may be versioned in accordance with some examples. Also, the term templates may refer to a file (e.g., an executable file) or a data arrangement linked to a process model and executable code, at least in some cases.

Configurator 128 may be configured to automatically (e.g., without user intervention), or responsive to user input, identify a subset of configuration data to be associated with an automated workflow template to select a subset of functionalities and behaviors that a process workflow may inherit. Continuing with the previous example of selecting application 180i, an associated automated workflow template may be configured to access data values, event data, and other configuration data. In this case, application 180i and its template may be configured to implement a function to “request dataset creation approval.” For example, configuration data may be used to create a first instance of an automated workflow template in accordance with first set of configuration data, such as generating a trigger to activate a process workflow based on an event when a form (e.g., an electronic form via a website) is submitted, as well as one or more actions to be performed based on the triggering event, such as actions of sending a notification e-mail and a process for requesting approval. Further, a first set of configuration data may also include the number and identity of users that can provide approval. The first set of configuration data may also include a configurable time limit for a pending request (e.g., upon which expiration of the time limit may automatically terminate a process). Next consider, a second set of configuration data being applied to form another instance of an automated workflow template, whereby second set of configuration data differs from the first set of configuration data. Therefore, modification of process models and process functionalities need not be created or developed (e.g., by skilled software developer) to implement different instances of an automated workflow template. Rather, configuration data, as variables, may be used to define workflow functionalities, whereby persons or users of any role may be capable to configure workflow processes.

Process model processor 129 may be configured to facilitate execution of instances of automated workflows (e.g., structural copies that may implement variable data to achieve a certain function) based a templated process workflow (e.g., a process workflow compliant with BPMN-based models, whereby, in some examples, executable objects of an object-oriented programming language, such as Java, may be configured to provide functionality and execution of an instance of an automated workflow. Further, process model processor 129 may be configured to receive configuration data, resultant workflow-generated data, and enriched or modified data, as well as any other data including metadata. Process model processor 129 may be further configured to transmit received data associated with execution of automated workflows to data sources 190 as federated data access 192 to extend, enrich and modify a portion of a knowledge graph to form an “active” knowledge graph. Also, process model processor 129 may be configured to store or access any number of created instances of automated workflow templates.

Governance logic module 123 may include logic configured to execute instructions to implement a variety of functions aimed to manage data associated with data catalogs and knowledge graphs. For example, data governance may relate to logic configured to detect, analyze, and manage a set of responsibilities and roles and a set of policies to enhance value of data through ensuring quality or integrity of data, as well as ensuring sufficient security of sensitive data, among other aims. In one example, governance logic module 123 may include logic to analyze data and metadata associated with workflows to compute whether there may be non-compliant data or metadata and, if so, governance logic module 123 may generate a data file including an insight as to the non-compliance. In some cases, governance logic module 123 may be configured to automatically obviate (e.g., using algorithms configured by machine learning and the like) the issue or determine a recommended action. For example, if a dataset, resource data, data products, data assets, and the like are determined to omit an assigned role of ‘data steward,’ governance logic module 123 may automatically generate a recommend data steward based on, for instance, characteristics of data steward user and the attributes of dataset data or metadata. In some cases, the terms dataset, resource data, data products, and data assets may be used interchangeably. In another example, governance logic module 123 may be configured to identify a status from any number of statuses (e.g., a status of one of “unassigned,” “pending,” “complete,” etc.) of an automated workflow, and may be configured further to automatically take action to resolve certain status conditions to ensure an automated workflow may operate optimally. Also, governance logic module 123 may be configured to provide user inputs at an interface to receive a user input to initiate resolution of certain statuses. Governance logic module 123 and its functionalities are not limited to the above-mentioned examples but can be configured to identify and resolve other deviations from one or more policies.

As shown, automated workflow engine 120 may include one or more data operations applications 130 to generate enriched metadata 132. One or more data operations applications 130 may include algorithms to determine quality or integrity of data, algorithms to monitor metadata and data associated with an automated workflow, algorithms that profile and classify data and metadata, algorithms to enable policy adherence, algorithms to generate or more models, among other algorithms configured to generate enriched metadata 132.

Structures and/or functionalities depicted in FIG. 1A as well as other figures herein, may be implemented as software, applications, executable code, application programming interfaces (“APIs”), processors, hardware, firmware, circuitry, or any combination thereof. In one or more examples, one or more structural and/or functional elements described in FIG. 1A, as well as below, may be implemented in hardware or software, or both, and optionally may implement any structure or functionality described in U.S. patent application Ser. No. 17/707,896, filed on Mar. 29, 2022, and titled “Generating and Analyzing a Data Model to Identify Relevant Data Catalog Data Derived from Graph-Based Data Arrangements to Perform an Action.” Note, too, that graph-based data of a knowledge graph may include metadata, such as data representing row and column information, to represent or to access a graph-based knowledge graph, a graph-based ontology, a graph-based data catalog, a graph-based automated workflow template and its elements, and any other data arrangement associated with one or more tables. Also, a knowledge graph data arrangement of one or more data sources 190 may be implemented as a knowledge graph-as-a-service (e.g., “KGaaS”), such as a cloud-based KGaaS, and a data catalog may be implemented as a data-catalog-as-a-service (e.g., a cloud native “DCaaS”), according to some examples.

In various examples, entities and functionalities described herein associated with data or metadata need not be stored in a data store (e.g., a triple store), and each entity and functionality may be implemented to access data or metadata from any number of data stores or repositories of any database format including any format configured to implement one or more of structured data, semi-structured data, and unstructured data. In some examples, activation of an event at which data or metadata may be required to execute a process, such as a workflow process, the process using data and metadata from disparate data stores may be rendered as a logical entity. For example, data and metadata of entities such as a knowledge graph, an ontology, a data catalog, an automated workflow template, an instance of an automated workflow template, etc. may originate from various networked data stores and can be consumed logically as an entity.

Other examples of entities include examples include resources (e.g., resource data), data products, and data assets, as well as any other entity including either data or metadata, or both. As such, resources, data products, data assets, etc. may be accessed by a call to extract data from disparate data stores to form a logical representation of such entities. In various examples, as described herein, references to datasets (e.g., dataset data) or metadata (e.g., metadata data) may relate or be in association with any of the above-described entities.

In some examples, a resource (e.g., resource data) may include metadata or data structures that may include business terms, collections, datasets, projects, insights and the like. Resource data may refer to data in a data catalog and may include units of metadata describing a description of tabular data, a status description, personal identifiable information (“PII”), whether external use outside of an enterprise is authorized, whether a non-disclosure agreement (“NDA”) relates to a data resource, permissions associated with a resource, one or more relevant calculations for presentation in a user interface, and other resource-related data. As another example, data products may include datasets, data streams, data feeds, as well as APIs, code, data models, analytics models, dashboards, and the like. Yet, in another example, a data asset is an entity comprised of data, such as a data store or a database including data records, files, or datasets. In view of the foregoing, an automated workflow template, for example, and associated data (e.g., configuration data) may be referred to any of the above-described entities.

One or more structural and/or functional elements depicted in FIG. 1A may be configured to implement any number of statistical analytic programs, machine-learning applications, deep-learning applications, and the like. For example, automated workflow engine 120 and any of its components may include any number of predictive data modeling algorithms that may be configured to perform pattern recognition and probabilistic data computations to identify non-compliant events or data determined to violate a governance policy. For example, algorithms implemented herein may apply “k-means clustering,” or any other clustering data identification techniques to form clustered sets of data that may be analyzed to determine or learn optimal classifications of metadata data, associated attributes, and properties, as well as to identify any deviation from governance policies, and either implementing or recommending courses of action to resolve non-compliant data associated workflows and processing of the same. In some examples, automated workflow engine 120 and its components may be configured to detect patterns or classifications among datasets and metadata (e.g., associated with a data catalog) through the use of Bayesian networks, clustering analysis, as well as other known machine learning techniques or deep-learning techniques (e.g., including any known artificial intelligence techniques, or any of k-NN algorithms, linear support vector machine (“SVM”) algorithm, regression and variants thereof (e.g., linear regression, non-linear regression, etc.)), Bayesian inferences and the like, including classification algorithms, such as Naïve Bayes classifiers, or any other statistical, empirical, or heuristic technique). In other examples, predictive data modeling algorithms may be implemented to extract features and/or attributes from metadata, resources, data products, or data assets by identifying patterns of data, as well as any other process to characterize subsets of metadata.

In view of the foregoing, structures and/or functionalities depicted in FIG. 1A, as well as other figures herein, may be implemented to generated automated workflows that, for example, may forgo or omit a necessity to manually develop or derive a process workflow, such as modeled in BPMN. Thus, specialized knowledge of software developers may not be needed, at least in some cases. Further, enterprise customers and consumers of data may not need to rely on sellers of process workflow software to develop process workflows. Hence, cycle times to implement automated workflow may be decreased, as well as expenditure of resources. Also, enterprise customers and consumers of data may increase autonomy on deciding optimal workflows that may meet their needs in accordance with the processes described herein.

FIG. 1B depicts an illustrative example of an automated workflow template including a workflow process model, according to some examples. Diagram 140 includes an automated workflow template 168b including a workflow process model 168a. Workflow process model 168a is shown as a process model of a workflow process generalized and may be reused as, in some cases, workflow process model 168a may be configured as an immutable workflow process. In some examples, workflow process model 168a may be versioned (e.g., having multiple versions), whereby each version may be an immutable workflow process. Automated workflow template 168b is shown to include configuration data 169a to configuration data 169h which may be varied to modify steps of workflow process model 168a, thereby preserving a workflow process of a process model, while facilitating adaptation to a desired functionality based on implementation of parameters or data values in configuration data 169a to configuration data 169h as set forth in an automated workflow template. In some examples workflow process model 168a may be compliant with a Business Process Model and Notation (“BPMN”) standard. Therefore, data representing business process models implemented in a computing system platform or any distributed set of computing devices, such in the cloud, may be configured to modify functionalities of enterprise applications and execution of those enterprise applications. Thus, automated workflow template 168b may be configured to facilitate effective electronic development of, for example, knowledge graphs or data catalog, or both.

In this example, workflow process model 168a is modeled as a process to request changes to a workflow, such as creating, deleting, or editing metadata. In this process, workflow process model 168a may be configured to include one or more approvals to accept access to a workflow for modification. As shown, workflow process model 168a is called or initiated upon an event associated with a trigger 141, which activates functionality associated with workflow process model 168a. Configuration data 169a may be configured to include data values (e.g., alpha-numeric text, a string, a control data signal, etc., or other parameters or parametric values) to describe an event that initiates a process. For example, configuration data 169a may describe a triggering event as “when a request to access workflow is submitted.” The workflow transits to node 142, at which a system 143 may be configured to send notification at 144. Configuration data 169b may be configured to include parameters or data values to describe a configurable number of notifications (e.g., 2 notifications) and a configurable form of communication (e.g., via email, text, etc.) that system 143 may implement. In some examples, system 143 may be automated workflow engine 120 or any of its components, as depicted in FIG. 1A.

Referring back to FIG. 1B, workflow transitions, in accordance with a process model, may flow to decision logic 147a to 147c at which one or more approvers 146 may transmit data to either approve or reject a request by a requesting user or electronic user account to modify a workflow and/or metadata. Configuration data 169c may include one or more data values or parameters that describe whether one, two, three, or more approvers are to provide approval or rejections. Further, configuration data 169c may include data values parameters that identify enterprise roles or positions that may provide feedback to decision logic 147a to 147c. In at least one example, user identifiers (e.g., user names) or electronic user accounts (e.g., computer devices) may be specified as configuration data 169c for permission to grant approvals.

Next, the workflow process moves to timer function 149 at which a request to modify a workflow or metadata may be automatically rejected if a condition exists that a number of approvals have not be implemented in decision logic 147a to 147c. For example, if a threshold of approvers 146 did not provide approval, then the request is automatically rejected. The threshold of approvals may range, for example, 67% to 100% of all approvers 146 granting approval. In some examples, configuration data 169d may specify a period of time, such as 30 days, during which approvals may be accepted. After 30 days, if the threshold of approvals has not been met, the request is rejected.

If rejected, the workflow process flows via rejected path 165b to node 161 at which system 160 may “send a notification” 162 to a requesting user that a request to modify a workflow or metadata has been denied. System 160 may also send a notice of rejection to approvers 146 specified in configuration data 169c and/or 169g. Configuration data 169g may be configured to include data values or parameters to describe a configurable number of notifications, a configurable form of communication, or any other means of notification that system 160 may implement. Next, a workflow process in accordance with workflow process model 168a may transition to an action 166 as a function at which configuration data 169h from automated workflow template 168b may set forth a particular action, such as sending data representing a state of rejection to an analytics algorithm that monitors cumulative numbers of rejections as well as identities of approvers 146 who provided a rejection.

If approved, a workflow process may transit via approved path 165a to node 151 at which system 150 may be configured to “send a notification” 153 to a requesting user that a request to modify a workflow or metadata has been approved. System 150 may also send a notice of approval to approvers 146 specified in configuration data 169e. Configuration data 169e may be configured to include parameters as data values to describe a configurable number of notifications, a configurable form of communication, or any other means of notification that system 150 may implement. Further, system 150 may automatically change status 152 of the workflow under modification from an “unlocked” status to a “locked” status to prevent accesses until a requested modification has been completed. Also, system 150 may update an activity log at 154 to append and archive a workflow identifier to a data log designed to monitor any number of various workflows under modification. Next, a workflow process in accordance with workflow process model 168a, may transition to an action 164 function at which configuration data 169f from automated workflow template 168b may set forth a particular action, such as sending data representing permissions to a requesting user to access the workflow under modification.

Note that diagram 140 depicts a representative example in which automated workflow templates may be implemented and is a non-limiting example. That is, structures and functions described herein are configured to implement workflow process models having various degrees of complexity. Note, too, that systems 143, 150, and 160 may be implemented as automated workflow engine 120 or any of its components, as depicted in FIG. 1A.

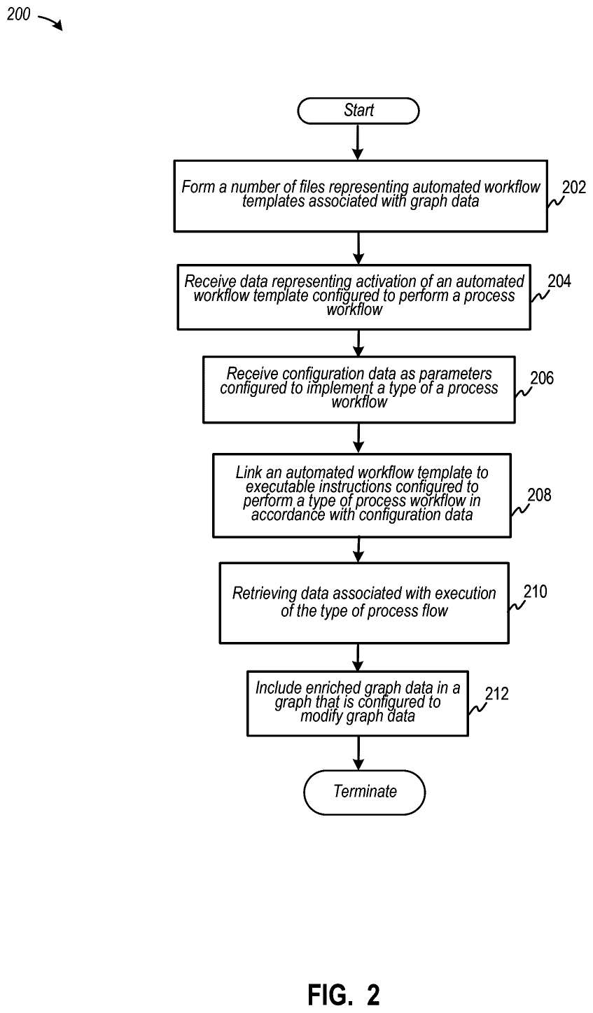

FIG. 2 is a flow diagram as an example of implementing automated workflow templates establishing automated workflows, according to some embodiments. Flow 200 example of implementing automated workflow templates in accordance with various examples described herein. At 202, any number of files may be formed to include data representing one or more automated workflow templates associated with a data arrangement that may include or be based on graph data, such as a knowledge graph or a data catalog. In one example, any number of data files may be formed to include one or more of data access templates configured to perform a process workflow to provide an ‘approval’ responsive to a request to access data, a ‘data enrichment template’ configured to identify types of data requiring action, a ‘metadata completeness template’ configured to modify metadata to establish a substantially complete set of metadata for a dataset, a metadata freshness template configured to assign a task to review a dataset periodically, an ‘automatic delegation template’ configured to delegate ownership to a dataset, and a ‘status-based template’ configured to assign a status to a dataset. The above-mentioned various automated workflow templates are non-limiting examples, and few or more may be implemented as well as another automated workflow template configured to perform a workflow process based on a specific workflow. Note that each of the automated workflow templates described above may derive specific functionality based on specific process models (e.g., specific BPMN-based models or any other process model having equivalent functionalities). And each of the automated workflow templates may have corresponding functionalities modified based on configuration data. For example, the above “data access” template may be based on a specific process model configured to request access to any type of data, metadata, or process workflow. Configuration data may be used to adjust any number of executable objects to perform each step of a process workflow to provide an approval responsive to a request to access data.

At 204, data representing activation of an automated workflow template configured to perform a process workflow may be received. For example, an automated workflow template may be stored in a template repository configured to store automated workflow templates. Each automated workflow template may be associated with a link to a user input at an interface. The link may be configured to receive data representing a request to select an automated workspace template for configuring to generate an instance of the selected automated workspace template. For example, a computing device associated with an electronic user account may configured to access an automated template preview portion of user interface from which an automated workflow template may be accessed for configuration (e.g., an automation template may be presented in a user interface having an “app store”-like functionality). Note that automated workflow templates, need not be stored at a single repository, whereby elements of an automated workflow template may reside in different data stores and may logically establish functionality responsive to the activation or at a time when a workflow process is activated, as configured by a configured an automated workflow template.

At 206, configuration data as parameters, including data values, may be received, whereby one or more parameters may be configured to implement a type of a process workflow. A type of a process workflow may be configured as an automated workflow template to implement a process model for facilitating a specific functionality defined by configuration data. In some examples, a configured automated workflow template may refer to an instance or instantiation of the same. In at least one example, a process model may be compliant with BPMN standards as well as any other equivalent business-related process model.

At 208, an automated workflow template may be linked or associated to executable instructions configured to perform a type of process workflow in accordance with configuration data, whereby a link from an automated workflow template may be a link to a process model. In some examples, an automated workflow template may be linked to executable objects of an object-oriented programming language to implement a process model. Examples of executable objects may be implemented in Java, Python, or any other programming language. Further, an automated workflow template may be linked to executable objects of an object-oriented programming language via an application programming interface (“API”) to implement a process model.

At 210, data associated with execution of a type of process flow may be retrieved, whereby such data may include metadata, configuration data, workflow process-related data, resultant data subsequent (or during) execution of objects in accordance with a process flow.

At 212, data retrieved in 210 may be implemented (e.g., uploaded) to modify a graph, such as a knowledge graph or a data catalog, to enrich or extend graph data associated with the knowledge graph or the date catalog.

In one example, a graph-based ontology may be implemented to generate a template based on a first subset of triples and may further implement configuration data associated with a second subset of triples to form an automated workflow template automatically, wherein a function of a template is to extend a data catalog or a knowledge graph, or both.

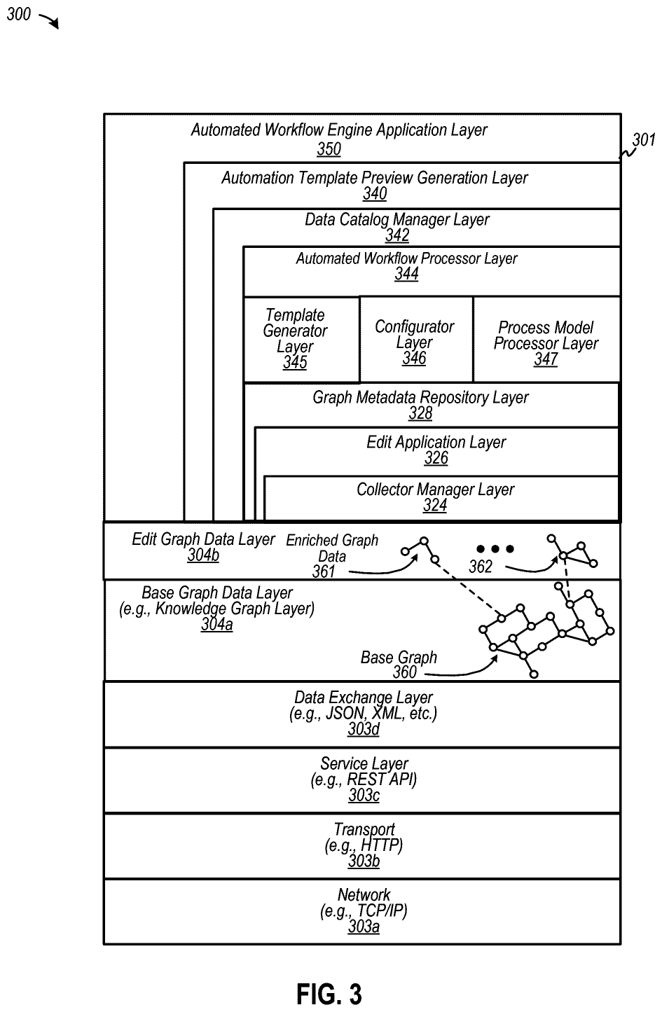

FIG. 3 illustrates an exemplary layered architecture for implementing an automated workflow engine application layer as an application architecture, according to some examples. Diagram 300 depicts application stack (“stack”) 301, which is neither a comprehensive nor a fully inclusive layered architecture to generate, implement, and execute automated workflows with data and metadata originating from disparately-formatted data sources to facilitate automated workflows, such as automated business-related workflows. One or more elements depicted in diagram 300 of FIG. 3 may include structures and/or functions as similarly-named or similarly-numbered elements depicted in other drawings, or as otherwise described herein, in accordance with one or more examples, such as described relative to any figure or description herein. Such layers are configured to provide corresponding functionality in an architecture as set forth herein.

Application stack 301 may include an automated workflow engine application layer 350 functionally built upon and including application template preview generation layer 340, whereby functionalities of layers 340 and 350 may be implemented as other similarly described functions, at least in some examples. As shown, data catalog manager layer 342 may be disposed upon and in electronic communication with any number of lower layers (e.g., layers 303a to 303d as well as layers 304a to 344) configured to facilitate configuration of automated workspace templates to effectuate processing workflows to the benefit of enterprise users. As shown, automated workflow process layer 344 may be configured to include applications or algorithms to provide for automated workflows as described herein. Automated workflow process layer 344 is shown to include a template generator application layer 345, a configurator application layer 346, and a process model processor application layer 347, each of which may function as described herein.

Diagram 300 includes a depiction of base graph data layer 304a, which may be an initial knowledge graph (e.g., a ‘core’ or ‘base’ knowledge graph). That is, a system including an automated workflow engine may ingest data from one or more data sources to identify a pool of data and establish a basis for forming a knowledge graph. As an example, base graph data layer 304a may include data (e.g., ingested data to form a graph) or stored and characterized as graph-based data 360, which may be formed as a knowledge graph layer 304a.

Graph metadata repository layer 328 is shown to include an edit application layer 326 and a collector manager layer 324. Graph metadata repository layer 328 may be configured to manage data in repositories including data that form a knowledge graph, which may be implemented to manage a data catalog. Collector manager layer 324 may include algorithms and/or applications to collect data from various data sources to form base graph data layer 304a and may be used to collect data subsequently to form edit graph data layer 304b as a part or enrichment of base graph data layer 304a. Edit application layer 326 may be configured to receive data from the generation and implementation of automated workflow templates based on execution of automated workflows. As shown, edit application layer 326 may be configured to generate enriched graph data 361 and 362, among others. And as such, edit application layer 326 may be configured to supplement or enrich data in base graph data layer 304 to form an “active” knowledge graph (e.g., in real or near-real time). Hence, while graph data 360, 361, and 362 may be disposed in disparate data stores, each may be linked, or stitched, logically together upon a call to access data or to upon uploading data, such as with a federated access (e.g., federated queries and the like).

Further, automated workflow process layer 344 may be disposed on data exchange layer 303d, which may implemented using any programming language, such as HTML, JSON, XML, etc., or any other format to effect generation and communication of requests and responses among computing devices and computational resources constituting an enterprise, an entity, and/or a platform configured to correlate data and information expeditiously, such as information regarding products or services aligned with data in targeted data sources compatible with data integration. Data exchange layer 303d may be disposed on a service layer 303c, which may provide a transfer protocol or architecture for exchanging data among networked applications. For example, service layer 303c may provide for a RESTful-compliant architecture and attendant web services to facilitate GET, PUT, POST, DELETE, and other methods or operations. In other examples, service layer 303c may provide, as an example, SOAP web services based on remote procedure calls (“RPCs”), or any other like services or protocols (e.g., APIs, such as REST APIs, etc.). In some cases, APIs may be implemented with Fetch API programmatic code, XHR (“XML HttpRequest”) API programmatic code, and equivalents thereof. Service layer 303c may be disposed on a transport layer 303b, which may include protocols to provide host-to-host communications for applications via an HTTP or HTTPS protocol, in at least this example. Transport layer 303b may be disposed on a network layer 303a, which, in at least this example, may include TCP/IP protocols and the like.

Any of the described layers of FIG. 3 or any other processes described herein in relation to other figures may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including, but not limited to, Python™, ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, JSON, Javascript™, Ajax, Perl, COBOL, Fortran, ADA, XML, MXML, HTML, DHTML, XHTML, HTTP, XMPP, PHP, and others, including SQL™, SPARQL™, Turtle™, etc., as well as any proprietary application and software provided or developed by data.world, Inc., of Austin Texas, U.S.A., or the like. The above-described techniques may be varied and are not limited to the embodiments, examples or descriptions provided.

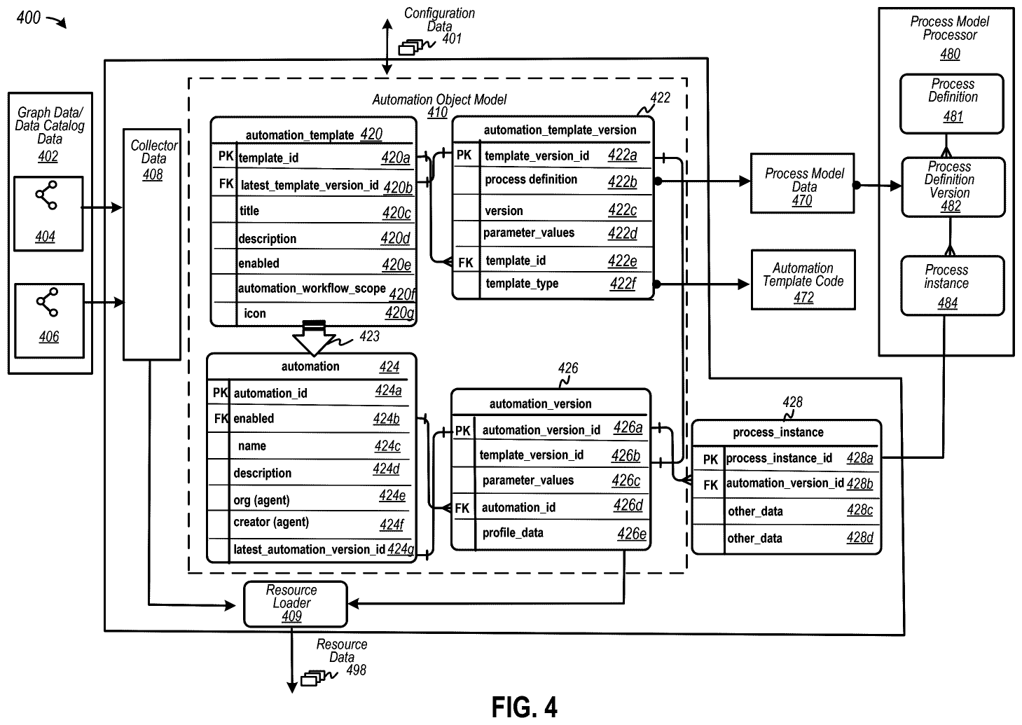

FIG. 4 depicts an example of an automation object model configured to implement an automated workflow template, according to some examples. Diagram 400 is an example of an automation object model 410 configured to define and provide functionality for an automated workflow template in accordance with the description herein. In the example shown, which is non-limiting and can be implemented in various configurations, data arrangements, and programming languages, an automated workflow may be implemented and executed.

As shown, automation object model 410 may include an automation template data arrangement 420 and an automation data arrangement 424. In accordance with at least one example, automation template data arrangement 420 may be configured to link to process model data 470, which may be deployed to a process model processor 480 to provide functionality of a workflow. As shown, process model processor 480 may include logic configured to access a process definition module 481, a process definition version 482, and a process instance 484. In some examples, process model processor 480 may be configured to receive data into a process model, such a BPMN model or other like models, for processing a process workflow. In one example, process model processor 480 (e.g., a Camunda, Inc.™ processor).

In some examples, a portion of process model processor 480 may be configured to include functionalities, such as process definition module 481 that may include one or more object structures representing executable processes. Process definition module 481 may include computerized monitoring and control of business processes. As shown, automation object model 410 may be configured to transmit data as process model data 470 to a process definition version module 482, which may be configured to receive data associated with a specific automated workflow template. Process model processor 480 may be configured to activate process instance 484, which may be configured to invoke execution of process definition version 482 as process instance 484.

Automation object model 410 may be configured to include automation template data arrangement 420 and an associated automation template version data arrangement 422, which may be configured to capture versioning of automation template 420, whereby automated templates formed to comply with automation template 420 may be modified, and thus versioned as automation template versions 422 while prior versions may remain immutable, in at least some cases. Data arrangement object 420 may be configured to provide generalized data to form an instance 423 of automation data template 420 as automation object 424. As shown in this example, automation template object (“automation_template”) 420 may be a tabular data arrangement that includes data representing a template identifier (“template_id”) 420a and an updated version identifier (“latest_template_version_id”) 420b, as well as data representing a title 420c, a description 420d, an indication whether automation template object 420 is enabled (“enabled”) 420e, a workflow scope defining a details of a workflow (“automation_workflow_scope”) 420f, and an icon 420g associated with an automation workflow template that may be implemented, such as in automation template preview 182 of FIG. 1A.

Automation template data arrangement 420 is configured to be linked to automation template version data arrangement (“automation_template_version”) 422, which may relate to a version of automation template data arrangement 420. A versioned data arrangement 422 may include data representing a template version identifier (“template_version_id”) 422a, a process definition identifier (“process definition”) 422b, a version identifier (“version”) 422c, one or more parameter values (“parameter_values”) 422d (e.g.), a versioned template identifier (“template_id”) 422e, and a template type (“template_type”) 422f that may describe a form of data arrangement. In some examples, a version identifier 422. In some cases, version identifier 422c may be implemented to provide semantic versioning.

Template identifier 420a may include data 420a to link of one or more versions 422 as identified by of an automation workflow template versions 422 as data representing a template identifier 422e that may indicate one or more automation template version identifiers 422e can be formed based on automation workflow template 420. Also, an updated version identifier 420b may be linked to a template version identifier 422a to identify a version of an automated workflow template. As such, activation of automation object model 410 may enable an automated workflow template 420 to reference a versioned form as automation workflow template version 422. In turn, process definition 422b may reference a process data model 470, such as a BPMN-based data model, and a template type 422f may reference automation template code 472, such as executable objects of an object-oriented programming language, such a Java®, Python™, or the like, to, for example, provide functionality of an automated workflow based on a BPMN model, an example of which is shown as process model processor 480.

As shown, activation of automation workflow template 420 may generate an “instance” or an instantiation 423 of data representing automation workflow template 420 as automation object 424. Automation data arrangement 424 may include data representing an identifier 424a referencing an instance of automation workflow template 420. An instance of automation workflow template 420 may implemented as a data arrangement 424, which may include an instantiation identifier 424. Data arrangement 424 may include an automation identifier (“automation_id”) 424a to reference a specific configuration of an automated workflow based on a dataset described as automation workflow template 420. Enabled 424b may include data configured to activate an instance of automation template 420, which may be linked to an automation identifier 426c to activate a version of an instance of an automated workflow to facilitate execution of an automated workflow process. Automation data arrangement 424 also may include data representing a name 424c, a description 424d of a workflow, a description of an organization (“org”) 424e configured to identify an organization, etc., a creator of a workflow 424f, and an identifier indicating a latest automation version 424g.

Further, an instance of automation object 424 may reference a versioned data arrangement, such as automation version (“automation_version”) 426. An instantiated version (“automation_version”) 426 may include data such as an identifier of an instance of an automation workflow template (“automation_version_id”) 426a configured to be linked to data representing one or more versions 428b of an instance of a process instance 428 generated by process model processor 480, a versioned template identifier (“template_version_id”) 426b, which may be linked to a version 422a of an automation template to identify a version of an automated workflow to be executed using process model data 470 in accordance with automation template code 472.

Data representing automation version 426 (e.g., as an automated workflow instance) may include data representing an instance of a version 426, which may be an instance 424 of an automated workflow template 420. Data representing automation version 426 may include an instance of automation version identifier (“automation_verion_id”) 426a, which may be linked to one or more automation process instances (“process_instance”) 428 at, for example, an automation version identifier (“automation_version_id”) 428b. Parameter data (“parameter_values”) 426c may include data to configure an automation 424 based on the automation template 420 in a way that allows support to operate complex sets of configurations. Profile data (“profile_data”) 426e may include data representing any portions of a knowledge graph, ontologies, or metadata profile statements to configure a data catalog and to provide functionality defined by automation template 420.

As shown, instantiated automation template version 426 may be linked to a process instance 428, which may a running instance of, for example, a BPMN model related to a specific automation implemented by automation template 420 generated at process instance 484, which, may be implemented in an application provided by Camunda, Inc., or any equivalent application or process as, for example, an BPMN engine. Upon activation of a workflow process, process instance 428 may be implemented to provide data representing a process instance identifier (“process_instance_id”) 428a configured to identify a specific workflow process as it implemented. Also, process instance 428 may include automation version identifier 428b, which may be referenced by automation version 426, which may be a tabular data arrangement, as well as other data 428c and 428d.

In accordance with some embodiments, configuration data 401 may be applied to automation object model 410 including one or more of tabular data arrangements 420, 422, 424, 426, and 428 (e.g., as tables) residing in, for example, a database, such as a Postgres™ database (e.g., a PostgreSQL™ database or an equivalent, or any other database or data format). In some examples, a data collector can be configured to retrieve collector data 406 from, for example, graph data/data catalog data 402, which may include data and metadata 404 and user profile data 406. As depicted, collector data 406 and data associated with automation version data 426 may be provided to a resource loader application 409 configured to generate resource data 496, which may include data as a portion of a data catalog, such as a web page as a resource of a data catalog linked to a workflow. In various examples, automation object model 410 may be configured to facilitate implementation of automated workflows in accordance with embodiments and descriptions herein.

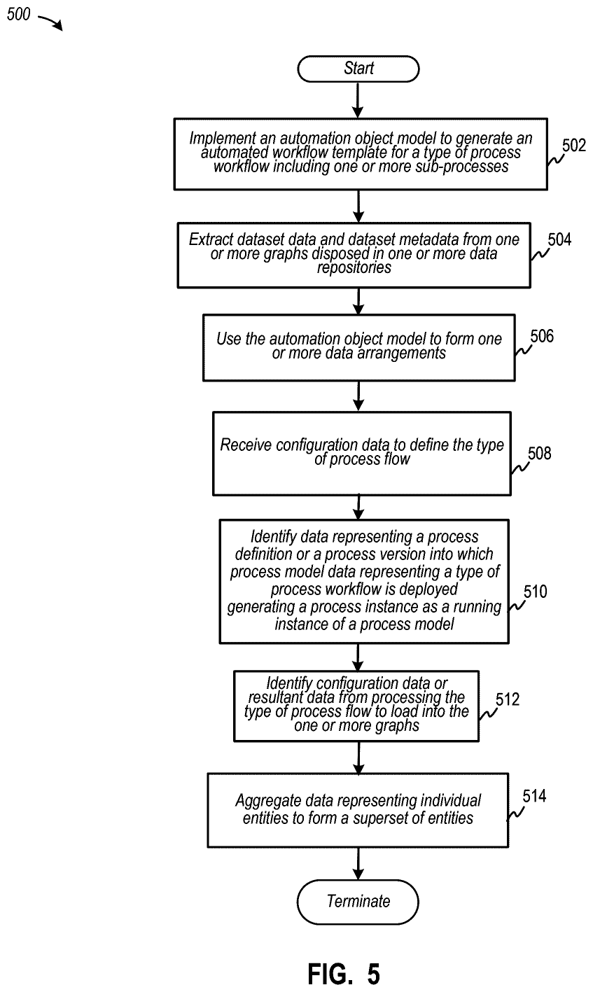

FIG. 5 is a flow diagram as an example of generating automated workflow templates, according to some embodiments. Flow 500 is an example of implementing automated workflow templates in accordance with various examples described herein. At 502, an automation object model may be configured to generate an automated workflow template for a type of process workflow including one or more sub-processes. As an example, a type of process workflow may be formed based on a workflow of an enterprise software platform using a process model, such as a process model compliant with a Business Process Model and Notation (“BPMN”) standard.

At 504, dataset data and dataset metadata from one or more graphs disposed in one or more data repositories may be extracted. In some cases, dataset data and dataset metadata may include resource data and, for example, may be stored as triples in triple stores. Further, dataset data and dataset metadata may originate from (or be stored in) a knowledge graph, an ontology, and/or a data catalog. As such, any data may be accessed via a collector or a connector application.

At 506, an automation object model may be used to form one or more data arrangements, which may include an automation template and an instance of the automation template (e.g., “automation data arrangement”). Further, an automation object model may be configured to include one or more data arrangements that can include an automation template version and an instance of the automation template version. In some cases, versioning can be implemented using semantic versioning or the like.

At 508, configuration data to define the type of process flow may be received. Examples of configuration data are described herein, such as in association with FIG. 1B and other figures.

At 510, data representing a process definition or a process version into which process model data representing a type of process workflow is deployed may be identified. In some examples, a process instance may be implemented as a running instance of a process model.

At 512, configuration data or resultant data from processing a type of process, such as an automated workflow, may be identified and configure to load into the one or more data arrangements, such as one or more portions of a knowledge graph or a data catalog. In some examples, a type of process may be a specifically configured BPMN process.

At 514, data representing one or more entities may be aggregated to form a superset of entities. For example, an aggregation of metadata that, for example, may be examples of entities that include resources, and other data, including metadata of a data catalog.

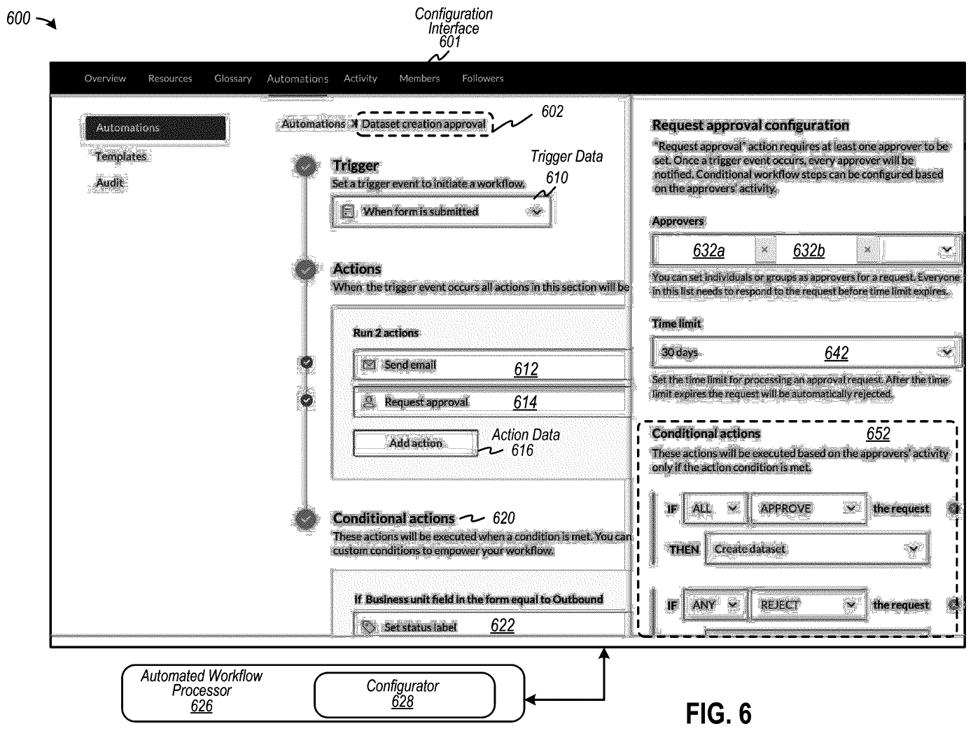

FIG. 6 depicts an example of an automated workflow processor configured to provide a configuration interface to establish an automated workflow, according to some examples. Diagram 600 depicts an automated workflow processor 626 including a configurator 628 configured to generate a configuration interface 601, which may be an example to configure a workflow according to some embodiments. In the example shown, configuration interface 601 may be implemented to configure creation of an approval of a created dataset 602. Initiation of an automated workflow may be triggered by an event, such as “when a form is submitted” 610. Actions of an automated workflow may include sending an email as indicated at user input 612, requesting approval at user input 614, and any other action implemented with user input 616. Configuration workflow interface 601 may further be configured to accept user inputs to add conditional actions 620, such as setting a status label 622 as part of an automated workflow. Also shown in diagram 600 are user inputs 632a and 632b to select users or electronic user accounts to provide approvals of a created dataset. In some cases, data 642 may be used to set a time limit with which an approval process for a created dataset is permissible. Conditional actions 652 may be implemented using “low-code/no-code” implementations to allow users without software development skills to generate automated workflows adapted to conform to certain business-related objectives.

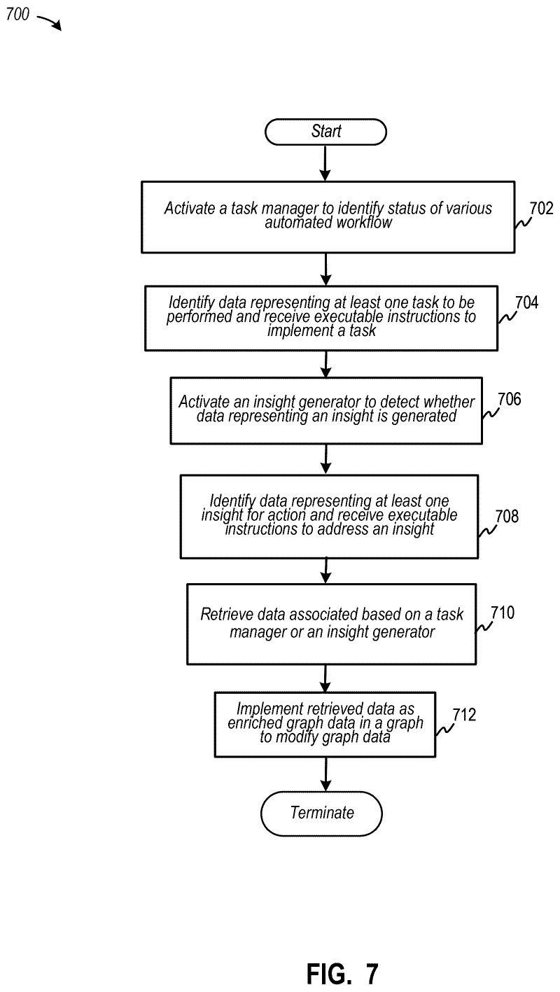

FIG. 7 is a flow diagram as an example of a process configured to enrich graph data, including a portion of a knowledge graph, according to some embodiments. Flow 700 is an example of facilitating automated workflow templates in accordance with various examples described herein. At 702, a task manager application may be activated to identify statuses of various automated workflows, such as whether a task in an automated workflow may be “unassigned,” “pending,” or “completed.” At 704, data representing at least one task to be performed may be identified at 704, whereby executable instructions to implement a task may be received and executed to facilitate a task. At 706, an insight generator may be activated to detect whether data representing an insight is generated. An insight may be represented as data describing or summarizing an attribute or characteristic of data representing an automated workflow or the performance thereof at 708. Thus, at 708, data representing at least one insight for action may identify executable instructions to address or resolve an insight. For example, if a dataset or an automated workflow omits an “owner,” a “data steward,” or any other user, then an insight may be generated to identify and resolve issues to align with governance policies. At 710, data associated with a task manager or an insight generator may be retrieved to implement a task manager application to manage tasks of an automated workflow. Or, at 710 an insight generation application may be implemented to analyze automated workflows and associated datasets to surface insights into uses of data associated with a knowledge graph and a data catalog. At 712, retrieved data may be implemented to enrich graph data by modifying graph data, such as in a knowledge graph.

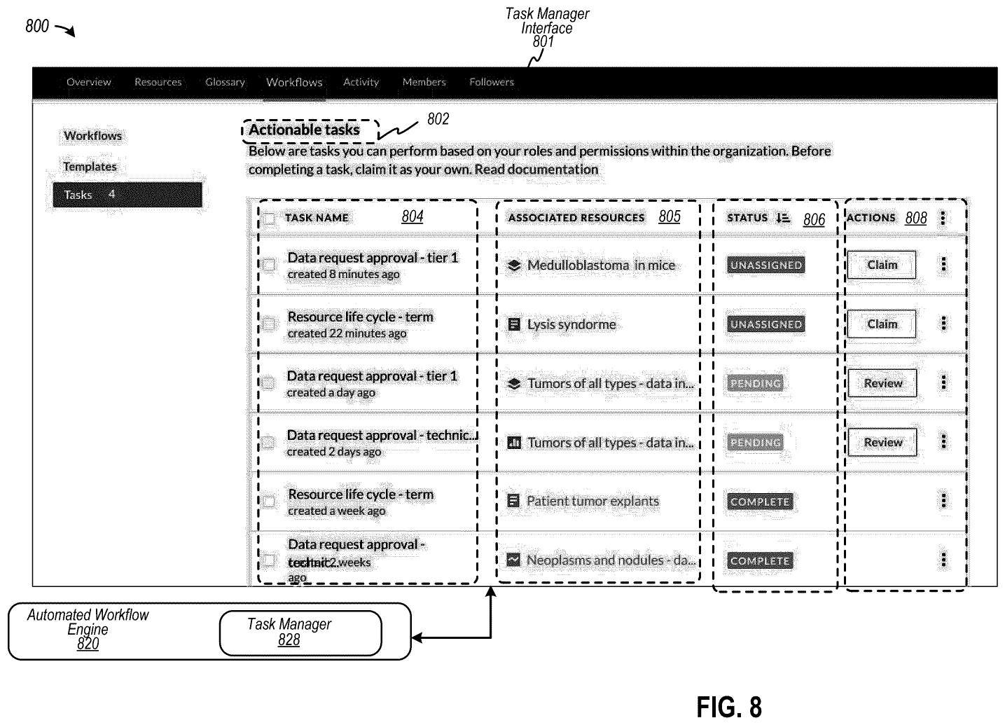

FIG. 8 depicts an example of a task manager interface to facilitate management of tasks of a workflow, according to some examples. Diagram 800 depicts an automated workflow engine 820 including a task manager 828 configured to generate a task manager interface 801, which may be an example to manage tasks or sub-processes of an automated workflow according to some embodiments. As shown, task manager interface 801 may include actionable tasks 802, each of which may be identified by a task name 804 that may correspond to an associated resource 805, such as a dataset or a portion of a knowledge graph or a data catalog. Further, a task name 804 may also correspond to a status 806 and potential action 806 to be executed.

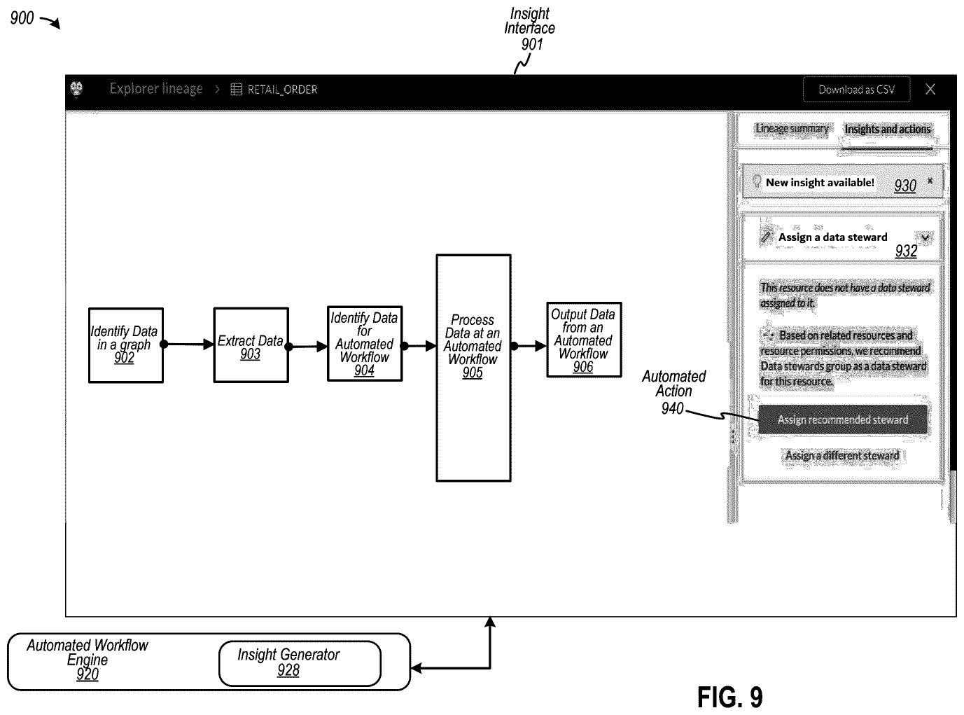

FIG. 9 depicts an example of an insight interface to facilitate management processes of an automated workflow, according to some examples. Diagram 900 depicts an automated workflow engine 920 including an insight generator 928 configured to generate an insight interface 901, which may be an example to provide information and management insights into workflow tasks or sub-processes of an automated workflow, according to some embodiments.

As shown, insight interface 901 may include actionable tasks 904, such as in this example, assigning a data steward with user input 932 or automatically as an automated action 940. Insight interface may be configured to depict an automated workflow process including identifying data in a graph 902, such as a portion of a knowledge graph or a data catalog, extracting data 903, and identifying data 904 for use with an automated workflow. Further, insight generator 928 may be configured to identify process data 905 of an automated workflow and analyze output data 906 of an automated workflow to generate an insight or characteristic of data representing an automated workflow or operation thereof. In the example shown, insight generate 928 may be configured to identify that a new insight is available 930, which in this case, is an insight into an automated workflow that omits an identified data steward (or any other information). Such automated insights may provide robust workflows for an enterprise.

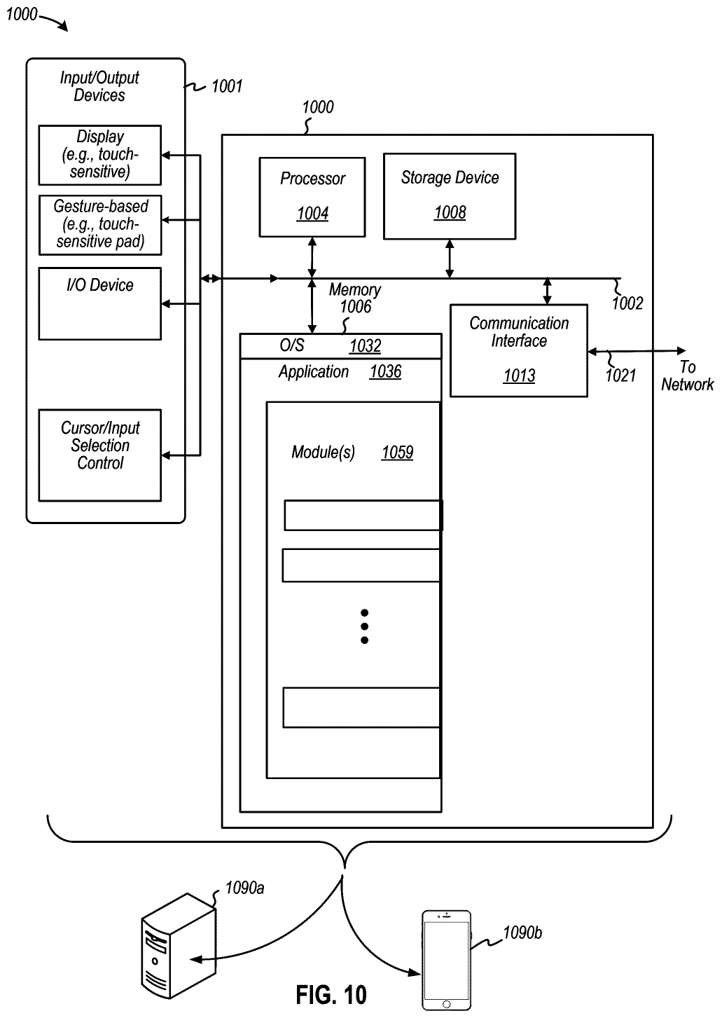

FIG. 10 illustrates examples of various computing platforms configured to provide various functionalities to components of a computing platform 1000 configured to provide functionalities described herein. Computing platform 1000 may be used to implement computer programs, applications, methods, processes, algorithms, or other software, as well as any hardware implementation thereof, to perform the above-described techniques.

In some cases, computing platform 1000 or any portion (e.g., any structural or functional portion) can be disposed in any device, such as a computing device 1090a, mobile computing device 1090b, and/or a processing circuit in association with initiating any of the functionalities described herein, via user interfaces and user interface elements, according to various examples.

Computing platform 1000 includes a bus 1002 or other communication mechanism for communicating information, which interconnects subsystems and devices, such as processor 1004, system memory 1006 (e.g., RAM, etc.), storage device 1008 (e.g., ROM, etc.), an in-memory cache (which may be implemented in RAM 1006 or other portions of computing platform 1000), a communication interface 1013 (e.g., an Ethernet or wireless controller, a Bluetooth controller, NFC logic, etc.) to facilitate communications via a port on communication link 1021 to communicate, for example, with a computing device, including mobile computing and/or communication devices with processors, including database devices (e.g., storage devices configured to store atomized datasets, including, but not limited to triplestores, etc.). Processor 1004 can be implemented as one or more graphics processing units (“GPUs”), as one or more central processing units (“CPUs”), such as those manufactured by Intel® Corporation, or as one or more virtual processors, as well as any combination of CPUs and virtual processors. Or, a processor may include a Tensor Processing Unit (“TPU”), or equivalent. Computing platform 1000 exchanges data representing inputs and outputs via input-and-output devices 1001, including, but not limited to, keyboards, mice, audio inputs (e.g., speech-to-text driven devices), user interfaces, displays, monitors, cursors, touch-sensitive displays, touch-sensitive inputs and outputs (e.g., touch pads), LCD or LED displays, and other I/O-related devices.

Note that in some examples, input-and-output devices 1001 may be implemented as, or otherwise substituted with, a user interface in a computing device associated with, for example, a user account identifier in accordance with the various examples described herein.

According to some examples, computing platform 1000 performs specific operations by processor 1004 executing one or more sequences of one or more instructions stored in system memory 1006, and computing platform 1000 can be implemented in a client-server arrangement, peer-to-peer arrangement, or as any mobile computing device, including smart phones and the like. Such instructions or data may be read into system memory 1006 from another computer readable medium, such as storage device 1008. In some examples, hard-wired circuitry may be used in place of or in combination with software instructions for implementation. Instructions may be embedded in software or firmware. The term “computer readable medium” refers to any tangible medium that participates in providing instructions to processor 1004 for execution. Such a medium may take many forms, including but not limited to, non-volatile media and volatile media. Non-volatile media includes, for example, optical or magnetic disks and the like. Volatile media includes dynamic memory, such as system memory 1006.

Known forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can access data. Instructions may further be transmitted or received using a transmission medium. The term “transmission medium” may include any tangible or intangible medium that is capable of storing, encoding, or carrying instructions for execution by the machine, and includes digital or analog communications signals or other intangible medium to facilitate communication of such instructions. Transmission media includes coaxial cables, copper wire, and fiber optics, including wires that comprise bus 1002 for transmitting a computer data signal.

In some examples, execution of the sequences of instructions may be performed by computing platform 1000. According to some examples, computing platform 1500 can be coupled by communication link 1021 (e.g., a wired network, such as LAN, PSTN, or any wireless network, including WiFi of various standards and protocols, Bluetooth®, NFC, Zig-Bee, etc.) to any other processor to perform the sequence of instructions in coordination with (or asynchronous to) one another. Computing platform 1000 may transmit and receive messages, data, and instructions, including program code (e.g., application code) through communication link 1021 and communication interface 1013. Received program code may be executed by processor 1004 as it is received, and/or stored in memory 1006 or other non-volatile storage for later execution.

In the example shown, system memory 1006 can include various modules that include executable instructions to implement functionalities described herein. System memory 1006 may include an operating system (“O/S”) 1032, as well as an application 1036 and/or logic module(s) 1059. In the example shown in FIG. 10, system memory 1006 may include any number of modules 1059, any of which, or one or more portions of which, can be configured to facilitate any one or more components of a computing system (e.g., a client computing system, a server computing system, etc.) by implementing one or more functions described herein.

The structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. These can be varied and are not limited to the examples or descriptions provided.

In some embodiments, modules 1059 of FIG. 10, or one or more of their components, or any process or device described herein, can be in communication (e.g., wired or wirelessly) with a mobile device, such as a mobile phone or computing device, or can be disposed therein.

In some cases, a mobile device, or any networked computing device (not shown) in communication with one or more modules 1059 or one or more of its/their components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figures can represent one or more algorithms. Or, at least one of the elements can represent a portion of logic including a portion of hardware configured to provide constituent structures and/or functionalities.

For example, modules 1059 or one or more of its/their components, or any process or device described herein, can be implemented in one or more computing devices (i.e., any mobile computing device, such as a wearable device, such as a hat or headband, or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, modules 1059 or one or more of its/their components, or any process or device described herein, can be implemented in one or more computing devices that include one or more circuits. Thus, at least one of the elements in the above-described figures can represent one or more components of hardware. Or, at least one of the elements can represent a portion of logic including a portion of a circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

1. A method comprising:
forming a plurality of files representing automated workflow templates associated with graph data;
receiving data representing activation of an automated workflow template configured to perform a process workflow;
receiving configuration data as parameters configured to implement a type of the process workflow;
linking the automated workflow template to executable instructions configured to perform the type of process workflow in accordance with the configuration data; and
retrieving data associated with execution of the type of process flow, the data including enriched graph data configured to modify the graph data.

2. The method of claim 1 wherein the graph data is one or more of a portion of a knowledge graph and a data catalog.

3. The method of claim 1 wherein linking the automated workflow template to the executable instructions comprises:
linking the automated workflow template to a process model.

4. The method of claim 1 wherein linking the automated workflow template to the executable instructions comprises:
linking the automated workflow template to a process model compliant with a Business Process Model and Notation (“BPMN”) standard.

5. The method of claim 1 wherein linking the automated workflow template to the executable instructions comprises:
linking the automated workflow template to executable objects of an object-oriented programming language to implement a process model.

6. The method of claim 1 wherein linking the automated workflow template to the executable instructions comprises:
linking the automated workflow template to executable objects of an object-oriented programming language via an application programming interface (“API”) to implement a process model.

7. The method of claim 1 further comprising:
implementing an instance of the automated workflow template.

8. The method of claim 1 further comprising:
implementing a graph-based ontology to generate a template based on a first subset of triples to further implement configuration data associated with a second subset of triples, wherein a function of the template is to extend a data catalog or a knowledge graph, or both.

9. The method of claim 1 further comprising:
storing automated workflow templates in a template repository, each of the automated workflow templates being associated with a link to a user input at an interface.

10. The method of claim 1 wherein forming the plurality of files representing automated workflow templates comprises:
forming one or more of a data access template configured to perform a process workflow to provide approval responsive to a request to access data, a data enrichment template configured to identify types of data requiring action, a metadata completeness template configured to modify metadata to establish a substantially complete set of metadata for a dataset, a metadata freshness template configured to assign a task to review a dataset periodically, an automatic delegation template configured to delegate ownership to a dataset, and a status-based template configured to assign a status to a dataset.

11. A system comprising:
a memory including executable instructions; and
a processor, responsive to executing the instructions, is configured to:
form a plurality of files representing automated workflow templates associated with graph data;
receive data representing activation of an automated workflow template configured to perform a process workflow;
receive configuration data as parameters configured to implement a type of the process workflow;
link the automated workflow template to executable instructions configured to perform the type of process workflow in accordance with the configuration data; and
retrieve data associated with execution of the type of process flow, the data including enriched graph data configured to modify the graph data.

12. The system of claim 11 wherein the graph data is one or more of a portion of a knowledge graph and a graph-based data catalog.

13. The system of claim 11 wherein the processor is further configured to:
link the automated workflow template to a process model.

14. The system of claim 11 wherein the processor is further configured to:
link the automated workflow template to a process model compliant with a Business Process Model and Notation (“BPMN”) standard.

15. The system of claim 11 wherein the processor is further configured to:
link the automated workflow template to executable objects of an object-oriented programming language to implement a process model.

16. The system of claim 11 wherein the processor is further configured to:
link the automated workflow template to executable objects of an object-oriented programming language via an application programming interface (“API”) to implement a process model.

17. The system of claim 11 wherein the processor is further configured to:
form an instance of the automated workflow template.

18. The system of claim 11 wherein the processor is further configured to:
implement a graph-based ontology to generate a template based on a first subset of triples to further implement configuration data including a second subset of triples,
wherein a function of the template is to extend a data catalog or a knowledge graph, or both.

19. The system of claim 11 wherein the processor is further configured to:
store automated workflow templates in a template repository, each of the automated workflow templates being associated with a link to a user input at an interface.

20. The system of claim 11 wherein the processor is further configured to:
form one or more of a data access template configured to perform a process workflow to provide approval responsive to a request to access data, a data enrichment template configured to identify types of data requiring action, a metadata completeness template configured to modify metadata to establish a substantially complete set of metadata for a dataset, a metadata freshness template configured to assign a task to review a dataset periodically, an automatic delegation template configured to delegate ownership to a dataset, and a status-based template configured to assign a status to a dataset
